(19) United States
(12) Patent Application Publication
(10) Pub. No.: US 2013/0025471 A1
(43) Pub. Date: Jan. 31, 2013

(54) PIE CRUST PROTECTOR PAN

(71) Applicant: REGINALD BONAMY, Apopka, FL (US)

(72) Inventor: REGINALD BONAMY, Apopka, FL (US)

(21) Appl. No.: 13/193,898

(22) Filed: Jul. 29, 2011

(51) Int. Cl. A21B 3/13

(52) U.S. Cl. 99/433

(57) ABSTRACT

A pie crust protector pan for baking pies includes a pan bottom, and an outer lip having a generally parallel orientation, an outwardly sloped wall interposed between the pan bottom and the outer lip, and a malleable crust protector capable of folding across the top of both of the outer lip and the pie crust. A pie crust protector can also include a plurality of marking strips capable of imparting an impression on the surface of the pie.

### BACKGROUND

### Field of the Invention

The present invention relates generally to bakeware, and more particularly to a pie pan capable of efficiently baking a pie, while providing a protective barrier that prevents the overcooking of the pie's crust.

There has been a long standing dilemma when baking pastries, specifically those with crust such as tarts and pies, concerning how to best bake these items to the appropriate internal temperature without burning the outer crust. Although generic pie pans having a fixed form and open top are well known in the art, there remains a need for a pie pan having an appendage that can be shaped or molded to fit a variety of pie sizes in order to protect the pie crust during baking.

In light of the above, it would be beneficial to provide a single device that is capable of positioning a pie for baking while also protecting the outer crust of the pie by allowing a user to cover a portion of the pie crust at an appropriate time during cooking with minimal disruption and minimal danger of injury.

### SUMMARY OF THE INVENTION

The present invention is directed to a baking pan. One embodiment of the present invention can include a pan bottom, and an outer lip having a generally parallel orientation, an outwardly sloped wall interposed between the pan bottom and the outer lip, and a malleable crust protector capable of folding across the top of both of the outer lip and the pie crust.

Another embodiment of the present invention can include a plurality of marking strips capable of imparting an impression on the surface of the pie.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a top view of a pie crust protection pan in accordance with one embodiment of the invention.

FIG. 2 is a side view of the pie crust protection pan in accordance with one embodiment of the invention.

FIG. 3 is a side section cutout view of the pie crust protection pan in accordance with one embodiment of the invention.

FIG. 4 is top view of the pie crust protection pan in operating, according to one embodiment of the invention.

FIG. 5 is another top view of the pie crust protection pan in operating, according to one embodiment of the invention.

FIG. 6 is a top view of the pie crust protection pan in accordance with an alternate embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

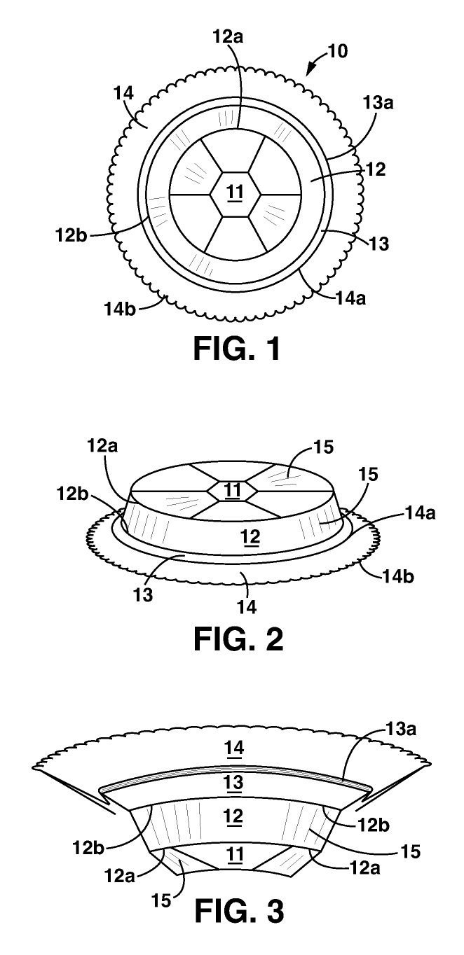

Although described herein as a “pie” pan, one of skill in the art will recognize that the invention may be utilized for any number of different baked goods such as tarts, pastries, pot pies and other such items. Moreover, for purposes of this description, the terms “upper,” “bottom,” “right,” “left,” “front,” “vertical,” “horizontal,” and derivatives thereof shall relate to the invention as oriented in FIG. 1.

FIGS. 1 and 2 illustrate one embodiment of a pie crust protector pan that is useful for understanding the inventive concepts disclosed herein. As shown, the device 10 includes a generally flat, annular central bottom portion 11, an outwardly sloping wall portion 12, a reinforced, circular outer lip 13, and a crust protector 14. In one preferred embodiment, the device 10 can be constructed from a single piece of lightweight metal such as foil, tin or aluminum, for example. Of course, other materials such as glass, composites and hardened metal are also contemplated.

The pan bottom 11 can act as the base for the device and can preferably include a flat/generally planar element having a circular shape.

The pan wall 12 can act to contain the pie contents within the pan and can include a lower section 12a connected to the outside periphery of the pan bottom, and an upper section 12b connected to the lip 13. In one preferred embodiment, the wall 12 can include a sloped circular member radiating outward at an appropriate angle to connect to the pan bottom 11 at the lower section 12a, and the pan lip 13 at the upper section 12b. Depending on the size of the pie to be made, each of the pan bottom and pan lip 13 will vary in dimension, however in most instances, the pan lip 13 will include a larger dimension than the pan bottom, resulting in the slope angle of the pan wall being greater than 90 degrees with respect to a vertical axis.

The outer lip 13 can act to define the uppermost crust area of the pie to be baked in the pan. To this end, the outer lip 13 can preferably include a flat circular shape that is secured to the top portion of the wall 12b. It is preferred that the outer lip 13 be oriented generally parallel to the bottom wall 11, as is common with pie pans, and include sufficient strength/reinforcement to hold and position a pie crust. Additionally, the outer lip 13 can include a raised bead/lip 13a along the outermost periphery for preventing pie materials from spilling out of the pan during preparation and/or baking.

The crust protector 14 can act as an adjustable cover for protecting the pie crust during baking. As such, the crust protector can preferably be constructed from a thin malleable material having a first end 14a that is permanently connected to the outer periphery of the outer lip 13, and a second end 14b capable of folding over the top of the outer lip itself. To this end, the crust protector 14 can bend over the lip of the pan 13 containing the crust of the pie during baking in order to prevent the pie crust from becoming overcooked.

As shown in FIG. 2, the device 10 can also include a plurality of grooves and/or rib-like structures 15 which can be secured to the pan bottom 11, the wall 12 and/or the lip 13, in order to provide additional strength and rigidity. In one preferred embodiment, ribs 15 can be stamped into the device 10 at a time of manufacture, however other methodologies are also contemplated. The reinforcement provided by the ribs will insure that the pan is resistant to the potential bending and flexing caused by any weight that is imposed on it. Additionally, the grooves can assist in the removal of steam that would otherwise be captured between the bottom surface of the pan and the pie, resulting in a more crisp and appealing crust.

As shown in FIG. 3, the annular rim of the pan 13 can be reinforced in a known fashion, by folding the material back onto itself multiple times; creating a thickness that will be resistant to deflection caused by any applied stress. Folding the material in this way can act to create the raised bead 13a, which is useful for acting as a termination point when a user presses dough into the rim of the pan, as is common practice during conventional pie making.

Additionally, folding the rim in this manner can act to form the pliable crust protector 14 from the same solitary sheet of thin metallic material as the other portions of the pan. For example, in one embodiment, after the outer rim 13 is initially folded onto itself and the outer ridge 13a is created, the additional sheet material can once again be folded onto itself to create the malleable crust protector 14. When folding the metal sheet on itself to form the crust shield, the second layer would be pressed flat and would not be as rigid as the rim itself, allowing it to be pliant and able to be shaped and formed around a variety of crust shapes. Moreover, the tenuity of the flexible protective component of the pie pan will allow it to be light and easily maneuverable by a user. Of course, other construction methodologies are also contemplated.

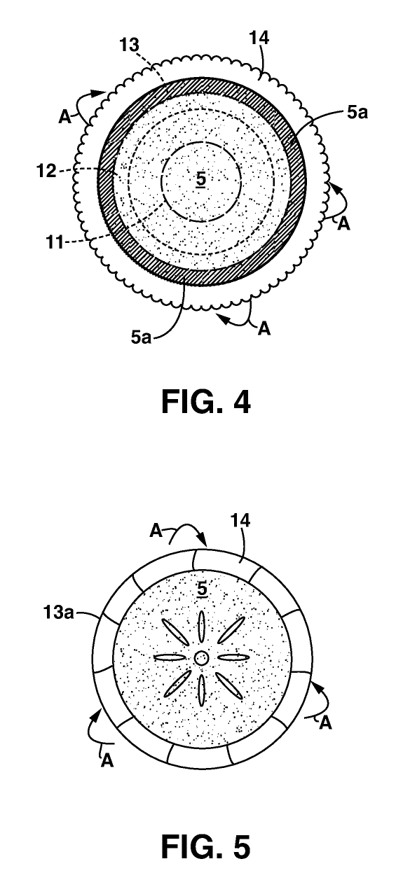

FIGS. 4 and 5 illustrate one embodiment of the device 10 in action. As shown, a pie 5 can be inserted into the pan with the pie crust 5a positioned on top of the pan lip 13, and the crust protector 14 in an open position (i.e. not covering the lip 13). As illustrated by arrow A, once the pie is placed in the pan, the crust protector 14 can be folded over the pie crust 5a at a desired time for baking.

Such a feature can allow a user to be able to begin baking the pie with the crust protector 14 in an open position, and then, as illustrated in FIG. 5, quickly sculpt it around the pie 5 with a fork or other utensils at the appropriate time during baking without ever removing the device from the oven. To this end, the crust protector can be pressed down over the pie crust 5a while leaving the inner portion of the pie 5 uncovered allowing the inner portion to continue baking while affording the outer crust protection from charring. Additionally, by permanently securing the crust protector to the pan, the device can be easily operated by a user without the need to secure the protector to a hot pie, thus reducing the risk of injury to a user.

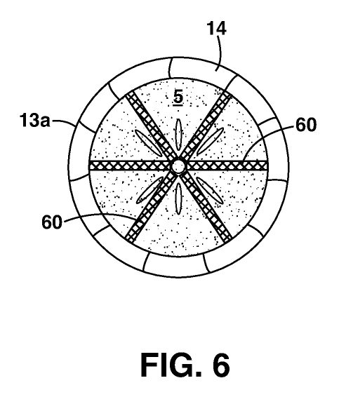

FIG. 6 illustrates an alternate embodiment of a pie crust protector pan 10 that further includes several marking strips 60 for designating pie slices. As described herein, each marking strip 60 can preferably be constructed from a thin flexible strand of elongated material (such as aluminum foil or tin, for example), which can be placed over the top of the pie 5 at a time of baking. As such, it is preferred that one end of each marking strip 60 be secured to the crust protector 14 and the other end be initially unattached to anything, so as to be capable of being positioned by the user in any number of unique ways. When the pie is baked with the marking elements in place, the thin piece of pie topping located beneath each marking strip will be slightly less browned, thus resulting in the pie retaining the line markings even after the marking strips 60 have been removed.

Such a feature can allow a user to designate pie slices prior to baking, which will assist the end user in proportioning and cutting the finished pie. Although described above as primarily for use in marking pie slices, one of skill in the art will recognize that one or more of the marking elements 60 can include a variety of different shapes and sizes which can be used to impart any number of designs and/or shapes into the finished pie.

Although illustrated above as including a circular design, the inventive concepts disclosed herein are not so limited. To this end, the device 10 can include any number of known shapes such as a square and a rectangle among others, for example.

As described herein, one or more elements of the pie crust protector pan 10 can be secured together utilizing any number of known attachment means such as, for example, glue, compression fittings and welds, among others. Moreover, although the above embodiments have been described as including separate individual elements, the inventive concepts disclosed herein are not so limiting. To this end, one of skill in the art will recognize that one or more individual elements such as the pan bottom 11, pan wall 12, outer lip 13, crust protector 14 and/or the marking elements 60 (including all sub components), for example, may be formed together as one continuous element, either through manufacturing processes, such as welding, casting, or molding, or through the use of a singular piece of material milled or machined with the aforementioned components forming identifiable sections thereof.

Accordingly, in one preferred embodiment, each above described element of the pie crust protector pan 10 can be constructed from a single piece of a thin stamped metallic material having a height and dimension similar to conventional bakeware, however other materials such as rigid metals and glass are also contemplated.

Therefore, a pie crust protector pan, as described above, can protect the outer portion of a pie or tart from being overcooked and burned while allowing the inner portion to be cooked to the desired temperature in a manner that is customizable by a user and safe to use.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A pie crust protector pan comprising:
a generally planar pan bottom having a first dimension;
a generally planar outer lip having a second dimension, said outer lip and said pan bottom having a generally parallel orientation;
an outwardly sloped pan wall interposed between the pan bottom and the outer lip; and
a crust protector having a first end and a second end, said first end being permanently affixed to the outer lip and the second end being configured to fold across a top portion of the outer lip and the pie crust.

2. The device of claim 1, wherein the crust protector is malleable and configured to bend easily.

3. The device of claim 2, wherein the crust protector is configured to cover the pie crust during baking in order to prevent the pie crust from becoming charred.

4. The device of claim 1, further comprising a plurality of thin elongated marking strips each configured to impart a mark on the pie during a baking process.

5. The device of claim 4, wherein each of the plurality of marking strips are configured to identify pie slices.

6. The device of claim 1, further comprising a plurality of ribs and grooves imparted onto at least one of the pan bottom, the pan wall, and the outer lip, said plurality of ribs and grooves being configured to increase a rigidity and strength of the pan.

7. The device of claim 1, wherein the pan is constructed from a single piece of thin metallic material.

8. The device of claim 1, wherein the outer lip is reinforced.

9. The device of claim 1, wherein the outer lip further includes a raised bead positioned along an outer periphery thereof.

10. The device of claim 1, wherein the pan includes a generally circular shape.

11. The device of claim 1, wherein the pan includes at least one of a square shape and a rectangular shape.

12. The device of claim 1, wherein each of the pan bottom, the pan wall, and the outer lip are constructed from a material comprising at least one of foil, tin, aluminum, glass, hardened metal and composite materials.
